(19) United States
(12) Patent Application Publication
(10) Pub. No.: US 2007/0093575 A1
(43) Pub. Date: Apr. 26, 2007

(54) Anaerobic adhesive compositions and water-blocking treatment of electrical wires with the same compositions

(76) Inventors: Tomoyasu Murakami, Hiroshima (JP); Shigenori Sato, Fukui (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/559,578

(22) PCT Filed: Jun. 7, 2004
(86) PCT No.: PCT/JP04/07944

§ 371 Date: Dec. 5, 2005

(30) Foreign Application Priority Data
Jun. 9, 2003 (JP) 2003-164033

(51) Int. Cl. C08K 5/41

(52) U.S. Cl. 524/155; 524/556; 524/356; 524/189

(57) ABSTRACT

[OBJECTIVE] The present invention provides anaerobic adhesive compositions which can be formulated with increases in both storage stability and speed of cure. [CONSTITUTION]An anaerobic adhesive composition, comprising: a polyacrylic ester capable of radical polymerization at room temperature; an organic peroxide; an anaerobic free radical generator capable of generating a free radical immediately after completion of contact with oxygen gas to facilitate the radical polymerization of the polyacrylic ester; and an organic hydrazide.

### TECHNICAL FIELD

The present invention relates to anaerobic adhesive compositions which function in the absence of oxygen in ambient atmosphere, and water-blocking treatment of electrical wires with the same compositions.

### Background Art

Anaerobic adhesives spontaneously initiate polymerization and then cure as soon as they are removed from contact with the air comprising oxygen gas, and are very widely employed in the field of mechanics to achieve the retention and tightness of small metallic pieces such as screws, nuts, bolts, pins, etc.

These anaerobic adhesive compositions are based, in very conventional manner, on a mixture of dimethacrylic esters capable of radical polymerization at room temperature, combined with organic peroxides, aromatic sulfides and a variety of organic amines as accelerators capable of providing increased speed of polymerization, and polymerization inhibitors capable of providing high storage stability, in order to achieve both speed of cure and storage stability required for intended use. See Japanese Laid-Open Publications H6-234956 (Reference 1) and 2000-26819 (Reference 2).

Aromatic tertiary amines, anilines, imidazole derivatives have been proposed as polymerization accelerators, which can facilitate the polymerization by controlling the composition and/or content thereof. However, in many cases, such polymerization accelerators have caused a problem that desired storage stability is hardly compatible with increased speed of cure.

Reference 1: Japanese Laid-Open Publication H6-234956

Reference 2: Japanese Laid-Open Publication 2000-26819

### DISCLOSURE OF THE INVENTION

The present invention is provided to solve said drawbacks. That is to say, it is the purpose of the present invention to provide anaerobic adhesive compositions which can be formulated with increases in both storage stability and speed of cure.

To solve the above-mentioned problems, the present invention provides anaerobic adhesive compositions comprising polyacrylic esters capable of radical polymerization at room temperature; organic peroxides; anaerobic free radical generators capable of generating free radicals immediately after completion of contact with oxygen gas to facilitate the radical polymerization of the polyacrylic esters; and organic hydrazides.

The anaerobic adhesive compositions in accordance with the present invention make possible exhibiting not only the storage stability over a long period of time in room temperature, but rapid cure.

### BEST MODE FOR CARRYING OUT THE INVENTION

“Polyacrylic ester(s)” which is suitable for the implementation of the present invention includes, without limitation, radically-polymerizable polyacrylic ester(s) in room temperature.

The term “acrylic ester(s)” as recited herein should be used in its broad sense including both acrylic esters and methacrylic esters.

Polyacrylic esters which can be utilized in accordance with the present invention include compounds having at least 2 (meth)acrylic ester groups therein, for example, poly(meth)acrylates of polyalcohols (for example, glycerins, polyethyleneglycols or polypropyleneglycols), epoxy (meth)acrylates or urethane (meth)acrylates.

To improve physical properties such as flexibility and adhesiveness, a mixture of acrylate monomers and methacrylate monomers may be used.

The organic peroxides which can be utilized in accordance with the present invention include ketone peroxides, diakyl peroxides, diacyl peroxides, peroxyesters, etc. While above-mentioned organic peroxides can be preferably employed, the use of hydroperoxides, for example, tert-butyl hydroperoxide, cumene hydroperoxide, tert-hexyl hydroperoxide, diisopropylbenzene hydroperoxide, etc. is particularly preferred.

Advantageously, the organic peroxides are used in an amount ranging from 0.05 to 10 parts by weight, preferably, 0.1 to 5 parts by weight, based on the polyacrylic esters (100 parts by weight) used in the anaerobic adhesive composition, so as to achieve both high storage stability and increased speed of cure.

Organic hydrazides are required to be blended as polymerization accelerators in the anaerobic adhesive composition in accordance with the present invention. If compounds other than organic hydrazides were used in the anaerobic adhesive composition, the characteristic effects intended by the invention, high storage stability and increased speed of cure could not be compatible.

The organic hydrazides which can be utilized in accordance with the present invention include carbodihydrazide, adipic acid dihydrazide, sebacic acid dihydrazide, isophthalic acid dihydrazide and maleic acid dihydrazide, or combination thereof.

In view of storage stability, isophthalic acid dihydrazide is preferably used.

The organic hydrazides are preferably used in an amount ranging from 0.05 to 10 parts by weight, more preferably, 0.1 to 5 parts by weight, based on the polyacrylic esters (100 parts by weight) used in the anaerobic adhesive composition.

To achieve further improved storage stability, ketones can be added to the anaerobic adhesive composition in accordance with the present invention. Ketones suitable for use in the present invention include acetophenone, acetone, cyclohexanone, methylisobutylketone, methylethylketone, diethylketone or combination thereof. Preferably, ketones are used in an amount of 0.1 to 20 parts by weight, based on the polyacrylic esters (100 parts by weight) used in the anaerobic adhesive composition.

Further, it is desirable to add organic sulfimides which function as curing accelerators to the anaerobic adhesive composition. Preferably, organic sulfimides include aromatic sulfimides, for example, benzoic sulfimide. Prefarably, organic sulfimides are used in an amount of 0.1 to 5 parts by weight, based on the polyacrylic esters (100 parts by weight) used in the anaerobic adhesive composition in order to obtain rapid cure.

The anaerobic adhesive compositions in accordance with the present invention are highly suitable for use in water-blocking treatment of electrical wires.

Lately, a number of devices mounted on cars or other industrial apparatus tend to be minimized and elaborated, and thus are easily affected by moisture. Therefore, the solution to the moisture leaking in connection parts or joint parts of electrical wires has been sought.

To solve above-mentioned problems, a method of providing improved water-blocking property (i.e., air-tightness) for electrical wires, comprising the steps of filling an adhesive in the clearance between element wires in conductors of electrical wires and curing the adhesive therein has been proposed. In view of foregoing, the anaerobic adhesive compositions in accordance with the present invention make it possible either to prevent moisture from penetrating into a device through the clearance between conductors, each of which is comprised of a plurality of element wires, or through the clearance between a conductor and insulating material which forms an insulating layer, or to prevent water-tree growth in insulating material.

Specifically, a process for carrying out water-blocking treatment of an electrical wire according to the present invention comprises the step of impregnating the electrical wire in the anaerobic adhesive composition in accordance with the present invention to fill the clearance between element wires of the electrical wire with the composition via capillarity. This process also allows subsequent polymerization of the composition to occur spontaneously as well as rapidly without the aid of heat or light.

In order to secure water-blocking property, i.e., air-tightness in the clearance between element wires, the anaerobic adhesive composition should cure rapidly on-site. If curing speed of the composition were not fast, there would happen bleeding of the composition or spreading of the composition through the length of electrical wires, resulting in electrical wires with poor water-blocking property.

Moreover, the anaerobic adhesive compositions should have low viscosity which is no more than 10 poise in order to provide satisfactory water-blocking property for an electrical wire. The experiments which had been undertaken by the present inventors showed when the composition having viscosity which was not less than 10 poise was applied to an electrical wire, it failed to reach the clearance between the element wires of the electrical wire. As a result, the electrical wire exhibited poor water-blocking property.

Since the viscosity of the anaerobic adhesive composition in accordance with the present invention can vary depending on, for example, the type of polyacrylic esters used, one can readily adjust its viscosity to the desired range, for example, by selection of polyacrylic esters to be used.

### EXAMPLES

The following examples are given to demonstrate the anaerobic adhesive compositions within the scope of the present invention disclosed herein and are not intended to be limitations upon the present invention.

The anaerobic adhesive compositions of Examples and Comparative Examples in accordance with the present invention each were formulated according to the composition ratio (part by weight) listed in Table 1 below.

“Polypropyleneglycol #400 dimethacrylate” in Table 1 is meant by poly(di)acrylic ester compound consisting of 1 molecule of polypropyleneglycol belonging to the class of polyalcohol and having 400 molecular weight and 2 molecules of methacrylic acid, and is capable of radical polymerization at room temperature.

Further, “hydroquinone” in Table 1 is a polymerization inhibitor widely employed in anaerobic adhesive compositions.

These anaerobic adhesive compositions were evaluated as follows.

The viscosity of the composition was measured at 25° C. by using the rotary viscosimeter obtained from TOKI SANGYO CO., LTD.

The curing time of composition was determined as follows. As soon as 0.05 ml (1 drop) of anaerobic adhesive composition was dropped on a sheet of 3 cm×3 cm copper plate at room temperature, a second sheet of the same sized cupper plate was placed on said copper plate. Thereafter, the anaerobic adhesive composition sandwiched between 2 sheets was gelled, and the length of time taken until these 2 sheets could not move with respect to each other any more (i.e., sensory test conducted by an inspector) was measured. In case curing time was no more than 2 minutes, the corresponding composition was found to have sufficient air-tightness. Therefore, the anaerobic adhesive compositions suitable for use in water-blocking treatment of electrical wires were considered to have curing time which is no more than 2 minutes. Moreover, the anaerobic adhesive compositions which had not cured by 30 minutes were indicated by “>30.”

In water-blocking treatment of electrical wires, air-tightness was tested as follows. While maintaining a 20 cm length of electrical wire having a diameter of 3 mm in the perpendicular direction, one carried out water-blocking treatment on its one tip. That is to say, the electrical wire was immersed to a depth of 3 cm in anaerobic adhesive composition for 10 seconds, was slowly lifted, and then was allowed to stand at room temperature for 24 hours. Thereafter, the electrical wire thus obtained was utilized as a test sample.

While said tip of the test sample being kept inserted in water under atmospheric pressure, compressed air was fed through the other tip of the test sample under gradually increasing pressure. In case the test sample showed no air bubble on its water-blocking treated tip until the pressure applied thereto exceeded 0.5 atm, the corresponding test sample was considered to have sufficient air-tightness and therefore was indicated by “O.” If any air bubbles were observed on the test sample under a pressure equal to or lower than 0.5 atm, the corresponding test sample was considered to have poor air-tightness and therefore was indicated by “X.”

In water-blocking treatment of electrical wires, gap filling property was evaluated on these test samples according to the following procedure. With respect to each of test samples, vinyl coating was stripped from its tip which had already been subjected to water-blocking treatment. In this case, the amount of the anaerobic adhesive composition which had been filled in the clearance between the element wires of the sample could be observed by the naked eye. The test sample which was filled without voids was indicated by “O.” Meanwhile, the test sample which had a higher number of voids and a relatively small filling amount was indicated by “X.”

The storage stability of the anaerobic adhesive composition was evaluated in the following manner. 50 ml of anaerobic adhesive composition was introduced in a 100 ml sealable polyethylene container. Thereafter, the sealed container was placed in an oven at 30° C., and the time (days) during which the composition had remained in its complete liquid state was measured. In case the duration of time was more than 60 days, the corresponding composition was indicated by “>60 days.”

These test results are shown in Table 1.

TABLE 1

| | | | | | | | Comparative | |
|---|---|---|---|---|---|---|---|---|
| | Example | | | | | | Example | |
| | 1 | 2 | 3 | 4 | 5 | 6 | 1 | 2 |
| Polypropyleneglycol | 80 | 80 | 80 | 80 | — | 50 | 80 | 50 |
| #400 | | | | | | | | |
| dimethacrylate | | | | | | | | |
| Urethane acrylate* | 20 | 20 | 20 | 20 | 20 | 50 | 20 | 50 |
| 2-hydroxypropyl | — | — | — | — | 80 | — | | |
| methacrylate | | | | | | | | |
| o-benzoic sulfimide | 2 | 2 | 2 | 2 | 2 | 2 | 2 | 2 |
| Adipic acid | 1.5 | 1.5 | — | — | — | — | — | — |
| dihydrazide | | | | | | | | |
| Isophthalic acid | — | — | 1.5 | 1.5 | 1.5 | 1.5 | — | — |
| dihydrazide | | | | | | | | |
| N,N-dimethylaniline | — | — | — | — | — | — | 1.5 | — |
| 1,2-dimethylimidazole | — | — | — | — | — | — | — | 1.5 |
| Methylethylketone | — | 10 | — | — | 10 | — | — | — |
| Cyclohexanone | — | — | 10 | 10 | — | 10 | — | — |
| tert-Butyl | 1.5 | 1.5 | 1.5 | 1.5 | 1.5 | 1.5 | 1.5 | 1.5 |
| hydroperoxide | | | | | | | | |
| Hydroquinone | 0.03 | 0.03 | 0.03 | 0.03 | 0.03 | 0.03 | 0.03 | 0.3 |
| Viscosity of liquid | 0.72 | 0.53 | 0.73 | 0.55 | 0.44 | 16.0 | 0.74 | 0.70 |
| (poise) | | | | | | | | |
| Curing time (min.) | 2 | 2 | 1.5 | 1.5 | 2 | 1.5 | 1.5 | >30 |
| Air-tightness | ◯ | ◯ | ◯ | ◯ | ◯ | X | ◯ | X |
| Gap filling | ◯ | ◯ | ◯ | ◯ | ◯ | — | ◯ | X |
| property | | | | | | | | |
| Storage stability | 30 days | >60 days | >60 days | >60 days | >60 days | 26 days | 1 day | 15 days |
| (30° C.) | | | | | | | | |

According to Table 1, Examples 1 through 6 of the anaerobic adhesive composition in accordance with the present invention cured in no more than 2 minutes, suggesting that the anaerobic adhesive compositions in accordance with the present invention are suitable for use which needs highly rapid cure. Regarding the storage stability, the above results proved that the compositions could be stored safely over a long period of time(≧26 days). The conventional anaerobic adhesive composition (i.e., Comparative Example 1) containing, as a curing accelerator, N-dimethylaniline which was not combined with organic hydrazides had only a short shelf time (1 day). Although another conventional anaerobic adhesive composition (i.e., Comparative Example 2) containing 1,2-dimethylimidazole had a subject measure of storage stability, it could not cure in 30 minutes and did not have enough air-tightness to be used in water-blocking treatment of electrical wires.

Moreover, Examples 1 through 5 of the anaerobic adhesive composition in accordance with the present invention had viscosity of no more than 10 poise, indicating that these compositions, when used in water-blocking treatment of electrical wires, would exhibit excellent gap filling property and satisfactory air-tightness. Although Example 6 having relatively high viscosity index was not suitable for use in water-blocking treatment of electrical wires, it could be preferably used as screw locking agent, which is one of the typical application of anaerobic adhesive compositions.

### INDUSTRIAL APPLICABILITY

The anaerobic adhesive compositions in accordance with the present invention comprising polyacrylic esters capable of radical polymerization in room temperature; organic peroxides; anaerobic free radical generators capable of generating free radicals immediately after completion of contact with oxygen gas to facilitate the radical polymerization of the polyacrylic esters; and organic hydrazides make possible exhibiting not only the storage stability over a long period of time in room temperature, but highly desirable speed of cure.

By adjusting viscosity to equal to or less than 10 poise, the anaerobic adhesive compositions in accordance with the present invention can be safely stored over a long period of time, and also have excellent gap filling property as well as satisfactory air-tightness. Therefore, the anaerobic adhesive compositions in accordance with the present invention can be preferably used in water-blocking treatment of electrical wires.

In addition to above-mentioned uses, the anaerobic adhesive compositions in accordance with the present invention also can be preferably used as screw locking agent, etc.

1. An anaerobic adhesive composition, comprising:
a polyacrylic ester capable of radical polymerization at room temperature;
an organic peroxide;
an anaerobic free radical generator capable of generating a free radical immediately after completion of contact with oxygen gas to facilitate the radical polymerization of the polyacrylic ester; and
an organic hydrazide.

2. The anaerobic adhesive composition according to claim 1, wherein said organic hydrazide is used in an amount ranging from 0.05 to 10 parts by weight, based on the polyacrylic ester used therein.

3. The anaerobic adhesive composition according to claim 1, further including a ketone.

4. The anaerobic adhesive composition according to claim 3, wherein said ketone is used in an amount of 0.1 to 20 parts by weight, based on the polyacrylic ester used therein.

5. The anaerobic adhesive composition according to claim 1, wherein said organic hydrazide is isophthalic acid dihydrazide.

6. The anaerobic adhesive composition according to claim 1, further including bezoic sulfimide in an amount of 0.1 to 5 parts by weight, based on the polyacrylic ester used therein.

7. The anaerobic adhesive composition according to claim 1, wherein its viscosity is no more than 10 poise.

8. A process for carrying out water-blocking treatment of an electrical wire, comprising:
impregnating a clearance between element wires of the electrical wire with the anaerobic adhesive composition according to claim 1.
